(19) United States
(12) Patent Application Publication
(10) Pub. No.: US 2023/0331250 A1
(43) Pub. Date: Oct. 19, 2023

(54) METHOD AND APPARATUS FOR CONFIGURING DEEP LEARNING ALGORITHM FOR AUTONOMOUS DRIVING

(71) Applicant: MOBILINT INC., Seoul (KR)

(72) Inventor: Dongjoo SHIN, Guri-si (KR)

(73) Assignee: MOBILINT INC., Seoul (KR)

(21) Appl. No.: 18/336,535

(22) Filed: Jun. 16, 2023

Related U.S. Application Data
(63) Continuation of application No. PCT/KR2020/018864, filed on Dec. 22, 2020.

(30) Foreign Application Priority Data
Dec. 22, 2020 (KR) 10-2020-0180500

(51) Int. Cl. B60W 60/00; G06N 3/04; G06V 20/56; B60W 40/06

(52) U.S. Cl. CPC B60W 60/001; G06N 3/04; G06V 20/56; B60W 40/06; B60W 2555/20; B60W 2555/60

(57) ABSTRACT

Disclosed is a deep learning algorithm configuring method and device for autonomous driving. The method includes determining driving environment information of a vehicle based on input information including external image information of the vehicle, and external signal information, determining a deep learning model corresponding to the determined driving environment information and a deep learning parameter set of the deep learning model, and setting a deep learning algorithm, in which the determined deep learning parameter set is applied to the determined deep learning model, as a deep learning algorithm for autonomous driving of the vehicle.

### CROSS-REFERENCE TO RELATED APPLICATIONS

The present application is a continuation of International Patent Application No. PCT/KR2020/018864, filed on Dec. 22, 2020, which is based upon and claims the benefit of priority to Korean Patent Application No. 10-2020-0180500 filed on Dec. 22, 2020. The disclosures of the above-listed applications are hereby incorporated by reference herein in their entirety.

### BACKGROUND

Embodiments of the inventive concept described herein relate to a method and apparatus for setting a deep learning algorithm for autonomous driving, and more particularly, relate to a method and apparatus for adaptively setting a deep learning algorithm for autonomous driving depending on a driving environment of a vehicle.

Autonomous driving means that a vehicle system performs a vehicle operation on their own, without partial or complete driver intervention. To implement the autonomous driving, there is a need for an algorithm capable of controlling various situations or variables. As such, a deep learning algorithm having an artificial neural network structure that mimics a human neural network structure capable of analyzing various characteristics from a lot of data is being applied to autonomous driving.

The accuracy of this deep learning algorithm may be greatly affected by the surrounding environment of a vehicle. Accordingly, various technologies are being developed to increase the reliability of a deep learning algorithm, but many deep learning algorithms may not provide accuracy having a specific level or higher.

### SUMMARY

Embodiments of the inventive concept provide a method and device for adaptively setting a deep learning algorithm for autonomous driving depending on environmental information around a vehicle.

Problems to be solved by the inventive concept are not limited to the problems mentioned above, and other problems not mentioned will be clearly understood by those skilled in the art from the following description.

According to an embodiment, a deep learning algorithm configuring method for autonomous driving performed by an apparatus includes determining driving environment information of a vehicle based on input information including external image information of the vehicle, and external signal information, determining a deep learning model corresponding to the determined driving environment information and a deep learning parameter set of the deep learning model, and setting a deep learning algorithm, in which the determined deep learning parameter set is applied to the determined deep learning model, as a deep learning algorithm for autonomous driving of the vehicle.

In this case, the external signal information may include at least one of a global positioning system (GPS) signal, a broadcast signal related to a road on which the vehicle is driving, and a dedicated signal related to the road on which the vehicle is driving.

Moreover, the determining of the driving environment information includes inferring first driving environment information based on a deep learning algorithm using the external image information of the vehicle, obtaining second driving environment information by using the external signal information, and determining the driving environment information of the vehicle by using both the first driving environment information and the second driving environment information. The determining of the driving environment information may include, when first detailed information of the first driving environment information is different from second detailed information of the second driving environment information, determining the first detailed information or the second detailed information as detailed information of the driving environment information based on the comparison result of a probability value related to the first detailed information and a threshold value corresponding to the probability value. The threshold value may be set differently depending on a type of corresponding detailed information.

Furthermore, the type of the detailed information may include at least one of weather information of a location at which the vehicle is driving, type information about the road on which the vehicle is driving, congestion information about the road on which the vehicle is driving, visual field brightness information of the vehicle, information about a sun direction and an altitude, and legal information of the location at which where the vehicle is driving.

Besides, the determined deep learning model may be determined based on a first information set among the type of the detailed information. The determined deep learning parameter set may be determined based on a second information set including the first information set among the type of the detailed information.

In addition, the first information set may include the type information about the road on which the vehicle is driving.

Also, the determining of the driving environment information may be performed at a regular interval or in real time. When the driving environment information of the vehicle determined through the determining of the driving environment information is different from driving environment information of the vehicle determined immediately before, the determining of the deep learning model and the deep learning parameter set and the setting of the deep learning algorithm may be performed.

According to an embodiment, a deep learning algorithm configuring apparatus for autonomous driving includes a driving environment information determination unit that determines driving environment information of a vehicle based on input information including external image information of the vehicle, and external signal information, a deep learning model and deep learning parameter set determination unit that determines a deep learning model corresponding to the determined driving environment information and a deep learning parameter set of the deep learning model, and a deep learning algorithm setting unit that sets a deep learning algorithm, in which the determined deep learning parameter set is applied to the determined deep learning model, as a deep learning algorithm for autonomous driving of the vehicle.

Other details according to an embodiment of the inventive concept are included in the detailed description and drawings.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a diagram briefly illustrating a basic concept of an ANN;

FIG. 2 is a diagram schematically showing a deep learning algorithm configuring method, according to an embodiment of the inventive concept;

FIG. 3 is a diagram schematically showing a deep learning model and a deep learning parameter set applicable to the inventive concept; and

FIG. 4 is a diagram schematically showing a deep learning algorithm configuring apparatus and peripheral devices, according to an embodiment of the inventive concept.

### DETAILED DESCRIPTION

The above and other aspects, features and advantages of the inventive concept will become apparent from embodiments to be described in detail in conjunction with the accompanying drawings. The inventive concept, however, may be embodied in various different forms, and should not be construed as being limited only to the illustrated embodiments. Rather, these embodiments are provided as examples so that the inventive concept will be thorough and complete, and will fully convey the scope of the inventive concept to those skilled in the art. The inventive concept may be defined by the scope of the claims.

The terms used herein are provided to describe embodiments, not intended to limit the inventive concept. In the specification, the singular forms include plural forms unless particularly mentioned. The terms “comprises” and/or “comprising” used herein do not exclude the presence or addition of one or more other components, in addition to the aforementioned components. The same reference numerals denote the same components throughout the specification. As used herein, the term “and/or” includes each of the associated components and all combinations of one or more of the associated components. It will be understood that, although the terms “first”, “second”, etc., may be used herein to describe various components, these components should not be limited by these terms. These terms are only used to distinguish one component from another component. Thus, a first component that is discussed below could be termed a second component without departing from the technical idea of the inventive concept.

Unless otherwise defined, all terms (including technical and scientific terms) used herein have the same meaning as commonly understood by those skilled in the art to which the inventive concept pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Hereinafter, embodiments of the inventive concept will be described in detail with reference to accompanying drawings.

The inventive concept discloses a method for setting a deep learning algorithm for autonomous driving. In more detail, the inventive concept discloses a method of adaptively setting a deep learning algorithm for autonomous driving depending on a driving environment of a vehicle.

Prior to a description, the meaning of terms used in the present specification will be described briefly. However, because the description of terms is used to help the understanding of this specification, it should be noted that if the inventive concept is not explicitly described as a limiting matter, it is not used in the sense of limiting the technical idea of the inventive concept.

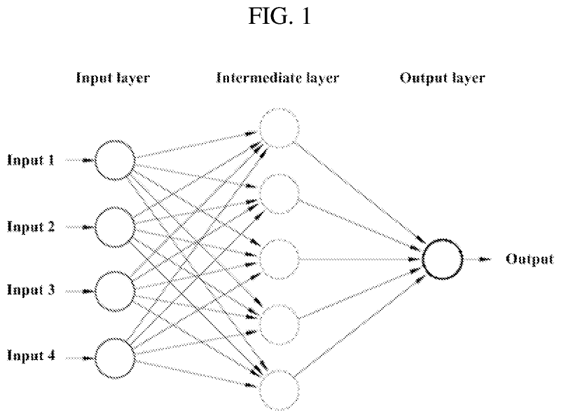

First of all, a deep learning algorithm is one of machine learning algorithms and refers to a modeling technique developed from an artificial neural network (ANN) created by mimicking a human neural network. The ANN may be configured in a multi-layered structure as shown in FIG. 1.

FIG. 1 is a diagram briefly illustrating a basic concept of an ANN.

As shown in FIG. 1, the ANN may have a hierarchical structure including an input layer, an output layer, and at least one or more intermediate layers (or hidden layers) between the input layer and the output layer. On the basis of a multi-layered structure, the deep learning algorithm may derive highly reliable results through learning to optimize a weight of an interlayer activation function.

The deep learning algorithm applicable to the inventive concept may include a deep neural network (DNN), a convolutional neural network (CNN), a recurrent neural network (RNN), and the like.

The DNN basically improves learning results by increasing the number of intermediate layers (or hidden layers) in a conventional ANN model. For example, the DNN performs a learning process by using two or more intermediate layers. Accordingly, a computer may derive an optimal output value by repeating a process of generating a classification label by itself, distorting space, and classifying data.

Unlike a technique of performing a learning process by extracting knowledge from existing data, the CNN has a structure in which features of data are extracted and patterns of the features are identified. The CNN may be performed through a convolution process and a pooling process. In other words, the CNN may include an algorithm complexly composed of a convolution layer and a pooling layer. Here, a process of extracting features of data (called a “convolution process”) is performed in the convolution layer. The convolution process may be a process of examining adjacent components of each component in the data, identifying features, and deriving the identified features into one sheet, thereby effectively reducing the number of parameters as one compression process. A process of reducing the size of a layer from performing the convolution process (called a “pooling process”) is performed in a pooling layer. The pooling process may reduce the size of data, may cancel noise, and may provide consistent features in a fine portion. For example, the CNN may be used in various fields such as information extraction, sentence classification, and face recognition.

The RNN has a circular structure therein as a type of ANN specialized in learning repetitive and sequential data. The RNN has a feature that enables a link between present learning and past learning and depends on time, by applying a weight to past learning content by using the circular structure to reflect the applied result to present learning. The RNN may be an algorithm that solves the limitations in learning conventional continuous, repetitive, and sequential data, and may be used to identify speech waveforms or to identify components before and after a text.

However, these are only examples of specific deep learning techniques applicable to the inventive concept, and other deep learning techniques may be applied to the inventive concept according to an embodiment.

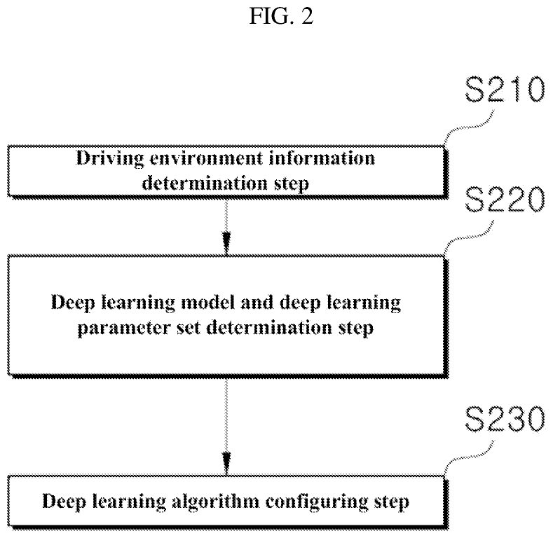

FIG. 2 is a diagram schematically showing a deep learning algorithm configuring method, according to an embodiment of the inventive concept.

As shown in FIG. 2, a learning algorithm configuring method according to an embodiment of the inventive concept may include a driving environment information determination step S210, a deep learning model and deep learning parameter set determination step S220, and a deep learning algorithm configuring step S230.

Hereinafter, for convenience of description, it is assumed that the deep learning algorithm configuring method according to an embodiment of the inventive concept is performed by a deep learning algorithm configuring apparatus. In this case, according to an embodiment, the deep learning algorithm configuring apparatus may be included in a vehicle system that performs autonomous driving. Alternatively, the deep learning algorithm configuring apparatus may include the vehicle system, conversely.

In operation S210, the deep learning algorithm configuring apparatus may determine driving environment information of a vehicle based on input information including image information outside the vehicle. In other words, the deep learning algorithm configuring apparatus may determine driving environment information of the vehicle by using input information including image information outside the vehicle.

As an example applicable to the inventive concept, the input information may include only the image information of an external image of a vehicle. Alternatively, as another example, in addition to the image information outside the vehicle, the input information may further include external signal information including at least one or more of a global positioning system (GPS) signal, a broadcast signal related to a road on which the vehicle is driving, and a dedicated signal related to the road on which the vehicle is driving. Here, the broadcast signal may be a signal transmitted to the air and may include a signal broadcast from a base station to all signal receivers located within a specific area. Moreover, the dedicated signal is a signal exclusively transmitted from the base station to the corresponding vehicle (or a signal receiver in the vehicle), and may include a signal transmitted only to the vehicle (or a signal receiver in the vehicle). In this case, the broadcast signal and/or the dedicated signal may include at least one or more of the following information.
A. Weather information (e.g., sunny, rain, snow, fog, etc.) of a location where the vehicle is driving.
B. The type (e.g., a downtown area, a highway, countryside, a school zone, etc.) of a road on which the vehicle is driving.
C. Congestion information about a road on which the vehicle is driving on (e.g., smooth, congested, etc.).
D. Visual field brightness information (e.g., day, evening, night, etc.) of a vehicle.
E. Information about a sun direction and an altitude (e.g., east, southeast, northwest, etc.).
F. Legal information of a location at which the vehicle is driving (e.g., Seoul, Busan, Los Angeles (LA), New York (NY), etc.).

As an example applicable to the inventive concept, the driving environment information may be determined/inferred in real time or at regular intervals by applying image information outside the vehicle to a separate deep learning algorithm.

As another example applicable to the inventive concept, the driving environment information may be determined/inferred in real time or at regular intervals by collectively using external signal information (e.g., GPS, Internet information, etc.) as well as the deep learning algorithm.

In more detail, the deep learning algorithm configuring apparatus according to an embodiment of the inventive concept may determine driving environment information as follows by collectively using a value of the result of applying the deep learning algorithm to (video) image information outside the vehicle, and external signal information received from the outside,
A. Inferring first driving environment information by using image information outside the vehicle. To this end, the deep learning algorithm configuring apparatus may infer the first driving environment information by applying a deep learning algorithm to image information outside the vehicle.
B. Obtaining second driving environment information by using external signal information. For example, the deep learning algorithm configuring apparatus may obtain each of pieces of detailed information described above from the external signal information.
C. Determining the vehicle's driving environment information by using both first driving environment information and second driving environment information. However, when the first detailed information of the first driving environment information is different from the second detailed information of the second driving environment information (in this case, the second detailed information corresponds to the first detailed information), determining the first detailed information or the second detailed information as the detailed information of the driving environment information based on the result of comparing a probability value related to the first detailed information with the corresponding threshold value.

In more detail, the deep learning algorithm configuring apparatus according to an embodiment of the inventive concept may finally determine vehicle driving environment information by comparing the first driving environment information with the second driving environment information. For example, when the first detailed information of the first driving environment information is the same as the second detailed information of the second driving environment information (in this case, the second detailed information corresponds to the first detailed information), the deep learning algorithm configuring apparatus may determine that the same detailed information is detailed information of vehicle driving environment information. However, when the first detailed information of the first driving environment information is different from the second detailed information of the second driving environment information, the deep learning algorithm configuring apparatus may determine that the first detailed information or the second detailed information is detailed information of the driving environment information, depending on the result of comparing the probability value related to the first detailed information with the corresponding threshold value.

At this time, the threshold value applicable to the inventive concept may be set differently depending on the type of corresponding detailed information. For example, the threshold value may be set differently depending on weather information around the vehicle, the type of a road on which the vehicle is driving, information about a region in which the vehicle is driving, and the like. As a more specific example, in the weather information, the possibility that first driving environment information inferred based on an external image (e.g., an image obtained from a camera installed outside the vehicle, etc.) of the vehicle is more accurate than second driving environment information based on external signal information is to be relatively high. Accordingly, the threshold value for the weather information may be set to be relatively low. On the other hand, in the region information, the possibility that second driving environment information based on external signal information (e.g., GPS, maps, Internet information, etc.) is more accurate than first driving environment information inferred based on an external image (e.g., an image obtained from a camera installed outside the vehicle, etc.) of vehicle is to be relatively high. Accordingly, a threshold value for the region information may be set to be relatively high (compared to the threshold value for the weather information).

As in the various embodiments described above, driving environment information of a vehicle according to an embodiment of the inventive concept may be determined based on a deep learning algorithm using the above-described input information. In other words, the driving environment information may be obtained through a deep learning algorithm to which the input information is applied. Through this process, the determined driving environment information may include at least one of the following.
A. Weather information (e.g., sunny, rain, snow, fog, etc.) of a location where the vehicle is driving.
B. The type (e.g., a downtown area, a highway, countryside, a school zone, etc.) of a road on which the vehicle is driving.
C. Congestion information about a road on which the vehicle is driving on (e.g., smooth, congested, etc.).
D. Visual field brightness information (e.g., day, evening, night, etc.) of a vehicle.
E. Information about a sun direction and an altitude (e.g., east, southeast, northwest, etc.).
F. Legal information of a location at which the vehicle is driving (e.g., Seoul, Busan, Los Angeles (LA), New York (NY), etc.).

Additionally, according to another embodiment of the inventive concept, the deep learning algorithm configuring apparatus may determine vehicle driving environment information by using only the external signal information. In other words, unlike the above-described embodiment, the deep learning algorithm configuring apparatus may include the external signal information, and may determine driving environment information of the vehicle by using input information excluding the image information outside the vehicle. In this case, the deep learning algorithm configuring apparatus may apply pieces of detailed information included in the external signal information to the driving environment information as they are, or may determine the driving environment information by separately determining each of the pieces of detailed information of the driving environment information by using the detailed information (e.g., determining specific detailed information of driving environment information by collectively using two or more pieces of detailed information included in the external signal information).

In step S220, the deep learning algorithm configuring apparatus may determine a deep learning model corresponding to the driving environment information determined in step S210 and a deep learning parameter set of the deep learning model.

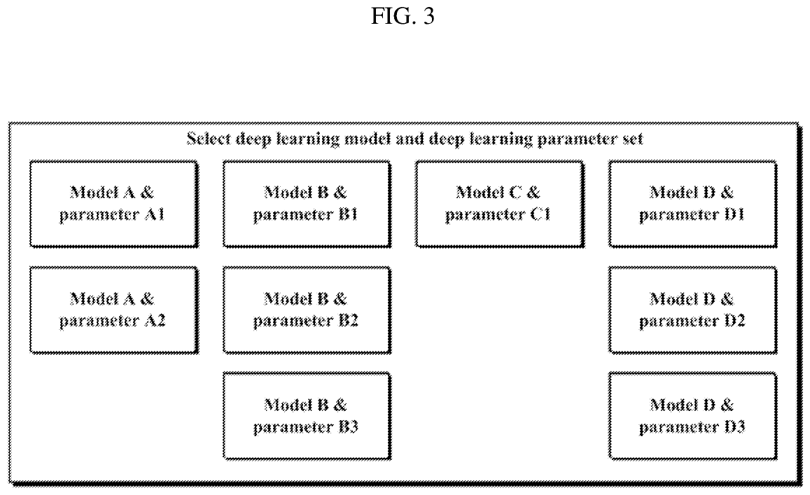

FIG. 3 is a diagram schematically showing a deep learning model and a deep learning parameter set applicable to the inventive concept.

As shown in FIG. 3, the deep learning algorithm setting method according to an embodiment of the inventive concept may be implemented based on one or more deep learning models and one or more deep learning parameter sets set for each of the deep learning models. Preferably, the deep learning algorithm setting method according to an embodiment of the inventive concept may be implemented by using a plurality of deep learning models and one or more deep learning parameter sets set for each of the deep learning models.

According to an embodiment of the inventive concept, in step S220, the deep learning algorithm configuring apparatus may determine an appropriate deep learning model and an appropriate deep learning parameter set depending on the driving environment information determined in step S210. For example, the deep learning algorithm configuring apparatus may determine a specific deep learning model, which is capable of having optimal performance in the corresponding environment, and a specific deep learning parameter set depending on the determined driving environment information.

In more detail, the deep learning algorithm configuring apparatus may determine the deep learning model and deep learning parameter set, which have optimal performance in the corresponding environment in consideration of visual field brightness information (or time information, e.g., night/day), weather information (e.g., sunny, rain, snow, fog, etc.), road information (e.g., a downtown area, a highway, a countryside, a school zone, etc.), or the like, which are included in the driving environment information.

Alternatively, the deep learning algorithm configuring apparatus may determine/select an optimal deep learning model based on a first information set among the driving environment information determined in step S210, and may determine/select an optimal deep learning parameter set for the determined deep learning model based on a second information set including the first information set among the driving environment information determined in step S210. In an embodiment of the inventive concept, each of the first information set and the second information set may include some or all of the above-described driving environment information.

For example, the deep learning algorithm configuring apparatus according to an embodiment of the inventive concept may determine/select deep learning models and deep learning parameter sets, which are different for each of the following cases, by using the determined driving environment information.
A. Case of highway driving at night: A first deep learning model (e.g., EfficientDet D2 model) and a first deep learning parameter set (e.g., a parameter set trained to be optimized for highway driving at night) among a plurality of deep learning parameter sets for the first deep learning model.
B. Case of highway driving in the daytime: A first deep learning model (e.g., EfficientDet D2 model) and a second deep learning parameter set (e.g., a parameter set trained to be optimized for highway driving in the daytime) among a plurality of deep learning parameter sets for the first deep learning model.
C. Case of city driving at night: A second deep learning model (e.g., EfficientDet D3 model) and a third deep learning parameter set (e.g., a parameter set trained to be optimized for city driving at night) among a plurality of deep learning parameter sets for the second deep learning model.
D. Case of city driving in the daytime: A second deep learning model (e.g., EfficientDet D3 model) and a fourth deep learning parameter set (e.g., a parameter set trained to be optimized for city driving in the daytime) among a plurality of deep learning parameter sets for the second deep learning model.

In the example above, the EfficientDet model may include an object detection model focused on efficiency that minimizes model size and maximizes performance. As such, in a case of highway driving, a fast response speed is required for high-speed driving, and thus the first deep learning model (e.g., EfficientDet D2 model) capable of implementing the fast response speed may be utilized. On the other hand, in a case of city driving, the driving speed of the vehicle is relatively slow, but roads are complicated and there are many pedestrians. Accordingly, it is necessary to detect many objects with high accuracy. To this end, the third deep learning model (e.g., EfficientDet D3 model), which is a larger model, may be utilized for city driving.

In step S230, the deep learning algorithm configuring apparatus may set a deep learning algorithm in which the determined deep learning parameter set is applied to the deep learning model determined in step S220, as a deep learning algorithm for autonomous driving of a vehicle. Accordingly, the deep learning algorithm configuring apparatus may apply a deep learning algorithm in which the determined deep learning parameter set is applied the deep learning model determined in step S220, as a deep learning algorithm for autonomous driving of the vehicle. In this way, the deep learning algorithm configuring apparatus may adaptively select/apply the deep learning algorithm for autonomous driving depending on surrounding environment information.

In an embodiment of the inventive concept, the driving environment information determination step may be performed at regular intervals or in real time. Furthermore, when driving environment information of the vehicle determined through the driving environment information determination step is different from driving environment information of the vehicle determined immediately before, a deep learning model and deep learning parameter set determination step and a deep learning algorithm configuring step may be performed.

In other words, the deep learning algorithm configuring apparatus according to an embodiment of the inventive concept may perform the above-described driving environment information determination step at regular intervals or in real time. In this case, the deep learning algorithm configuring apparatus may compare the driving environment information of the vehicle determined through the driving environment information determination step with the driving environment information of the vehicle determined immediately before. Next, when the driving environment information of the vehicle determined through the driving environment information determination step is different from the driving environment information of the vehicle determined immediately before, the deep learning algorithm configuring apparatus may additionally perform the deep learning model and deep learning parameter set determination step and the deep learning algorithm configuring step.

Through these operations, the deep learning algorithm configuring apparatus according to an embodiment of the inventive concept may efficiently and quickly set a deep learning algorithm for autonomous driving depending on driving environment information by minimizing unnecessary computational operations.

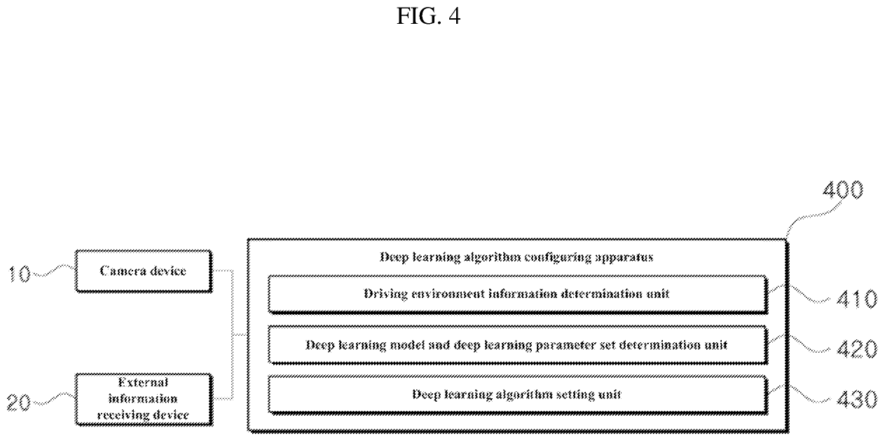

FIG. 4 is a diagram schematically showing a deep learning algorithm configuring apparatus and peripheral devices, according to an embodiment of the inventive concept.

According to an embodiment of the inventive concept, a deep learning algorithm configuring apparatus 400 for autonomous driving may be included in an autonomous driving control system of an autonomous driving vehicle or may be implemented as a separate device from the autonomous driving control system. As another embodiment, the deep learning algorithm configuring apparatus 400 may include an autonomous driving control system. In other words, according to the embodiment, the deep learning algorithm configuring apparatus 400 may be implemented as a part of the autonomous driving vehicle system or may be implemented as an entire system including the autonomous driving vehicle system.

As such, as illustrated in FIG. 4, the deep learning algorithm configuring apparatus 400 may include a driving environment information determination unit 410, a deep learning model and deep learning parameter set determination unit 420, and a deep learning algorithm setting unit 430.

As in the above-described driving environment information determination step, the driving environment information determination unit 410 may determine driving environment information by using pieces of input information obtained from a camera device 10 or an external information receiving device 20.

As in the deep learning model and deep learning parameter set determination step described above, the deep learning model and deep learning parameter set determination unit 420 may determine/select a deep learning model and a deep learning parameter set by using the driving environment information determined by the driving environment information determination unit 410. In this case, information about one or more deep learning models and information about one or more deep learning parameter sets for each deep learning model may be stored in a separate storage device (e.g., a database, etc.). In this case, the storage device may be included in the deep learning algorithm configuring apparatus 400 according to an embodiment of the inventive concept or may be placed outside the deep learning algorithm configuring apparatus 400.

As in the deep learning algorithm configuring step described above, the deep learning algorithm setting unit 430 may set the determined deep learning model and deep learning parameter set as a deep learning algorithm for autonomous driving.

As an example applicable to the inventive concept, the deep learning algorithm configuring apparatus 400 may be connected to the camera device 10 and the external information receiving device 20 installed in a vehicle to obtain related information from the camera device 10 and the external information receiving device 20. As another example applicable to the inventive concept, the deep learning algorithm configuring apparatus 400 may include the camera device 10 and the external information receiving device 20 to utilize related information obtained through the camera device 10 and the external information receiving device 20.

Moreover, as an example applicable to the inventive concept, the deep learning algorithm configuring apparatus 400 may be connected to an autonomous driving control device that controls autonomous driving within a vehicle system to provide a deep learning algorithm to the autonomous driving control device by setting/selecting the deep learning algorithm used by the autonomous driving control device. To this end, the deep learning algorithm configuring apparatus 400 may set the determined deep learning model and deep learning parameter set as a deep learning algorithm for autonomous driving by providing information about the deep learning model and deep learning parameter set determined by the autonomous driving control system. As another example, when the deep learning algorithm configuring apparatus 400 includes the autonomous driving control system, the deep learning algorithm configuring apparatus 400 may allow the autonomous driving control system to set the determined deep learning model and deep learning parameter set as a deep learning algorithm for autonomous driving.

Besides, the deep learning algorithm configuring apparatus 400 according to an embodiment of the inventive concept may operate depending on various deep learning algorithm configuring methods described above.

Additionally, a computer program according to an embodiment of the inventive concept may be stored in a computer-readable recording medium to execute various deep learning algorithm configuring methods for autonomous driving described above while being combined with a computer.

The above-described program may include a code encoded by using a computer language such as C, C++, JAVA, a machine language, or the like, which a processor (CPU) of the computer may read through the device interface of the computer, such that the computer reads the program and performs the methods implemented with the program. The code may include a functional code related to a function that defines necessary functions executing the method, and the functions may include an execution procedure related control code necessary for the processor of the computer to execute the functions in its procedures. Furthermore, the code may further include a memory reference related code on which location (address) of an internal or external memory of the computer should be referenced by the media or additional information necessary for the processor of the computer to execute the functions. Further, when the processor of the computer is required to perform communication with another computer or a server in a remote site to allow the processor of the computer to execute the functions, the code may further include a communication related code on how the processor of the computer executes communication with another computer or the server or which information or medium should be transmitted/received during communication by using a communication module of the computer.

The steps of a method or algorithm described in connection with the embodiments of the inventive concept may be embodied directly in hardware, in a software module executed by hardware, or in a combination thereof. The software module may reside on a Random Access Memory (RAM), a Read Only Memory (ROM), an Erasable Programmable ROM (EPROM), an Electrically Erasable Programmable ROM (EEPROM), a Flash memory, a hard disk, a removable disk, a CD-ROM, or a computer readable recording medium in any form known in the art to which the inventive concept pertains.

Although embodiments of the inventive concept have been described herein with reference to accompanying drawings, it should be understood by those skilled in the art that the inventive concept may be embodied in other specific forms without departing from the spirit or essential features thereof. Therefore, the above-described embodiments are exemplary in all aspects, and should be construed not to be restrictive.

According to an embodiment of the inventive concept, a deep learning algorithm capable of having optimal performance depending on a driving environment of a current vehicle may be set as a deep learning algorithm for autonomous driving. In this way, the accuracy and reliability of autonomous driving increase, thereby improving driving stability.

Effects of the inventive concept are not limited to the effects mentioned above, and other effects not mentioned will be clearly understood by those skilled in the art from the following description.

While the inventive concept has been described with reference to embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A deep learning algorithm configuring method for autonomous driving performed by an apparatus, the method comprising:
determining driving environment information of a vehicle based on input information including external image information of the vehicle, and external signal information;
determining a deep learning model corresponding to the determined driving environment information and a deep learning parameter set of the deep learning model; and
setting a deep learning algorithm, in which the determined deep learning parameter set is applied to the determined deep learning model, as a deep learning algorithm for autonomous driving of the vehicle.

2. The method of claim 1, wherein the external signal information includes at least one of a global positioning system (GPS) signal, a broadcast signal related to a road on which the vehicle is driving, and a dedicated signal related to the road on which the vehicle is driving.

3. The method of claim 2, wherein the determining of the driving environment information includes:
inferring first driving environment information based on a deep learning algorithm using the external image information of the vehicle;
obtaining second driving environment information by using the external signal information; and
determining the driving environment information of the vehicle by using both the first driving environment information and the second driving environment information, wherein the determining of the driving environment information includes:
when first detailed information of the first driving environment information is different from second detailed information of the second driving environment information, determining the first detailed information or the second detailed information as detailed information of the driving environment information based on the comparison result of a probability value related to the first detailed information and a threshold value corresponding to the probability value, and
wherein the threshold value is set differently depending on a type of corresponding detailed information.

4. The method of claim 3, wherein the type of the detailed information includes at least one of:
weather information of a location at which the vehicle is driving;
type information about the road on which the vehicle is driving;
congestion information about the road on which the vehicle is driving;
visual field brightness information of the vehicle;
information about a sun direction and an altitude; and
legal information of the location at which where the vehicle is driving.

5. The method of claim 4, wherein the determined deep learning model is determined based on a first information set among the type of the detailed information, and
wherein the determined deep learning parameter set is determined based on a second information set including the first information set among the type of the detailed information.

6. The method of claim 5, wherein the first information set includes the type information about the road on which the vehicle is driving.

7. The method of claim 1, wherein the determining of the driving environment information is performed at a regular interval or in real time, and
wherein, when the driving environment information of the vehicle determined through the determining of the driving environment information is different from driving environment information of the vehicle determined immediately before, the determining of the deep learning model and the deep learning parameter set and the setting of the deep learning algorithm are performed.

8. A deep learning algorithm configuring apparatus for autonomous driving, the apparatus comprising:
a driving environment information determination unit configured to determine driving environment information of a vehicle based on input information including external image information of the vehicle, and external signal information;
a deep learning model and deep learning parameter set determination unit configured to determine a deep learning model corresponding to the determined driving environment information and a deep learning parameter set of the deep learning model; and
a deep learning algorithm setting unit configured to set a deep learning algorithm, in which the determined deep learning parameter set is applied to the determined deep learning model, as a deep learning algorithm for autonomous driving of the vehicle.

9. The apparatus of claim 8, wherein the external signal information includes at least one of a GPS signal, a broadcast signal related to a road on which the vehicle is driving, and a dedicated signal related to the road on which the vehicle is driving.

10. The apparatus of claim 9, wherein the driving environment information determination unit is configured to:
infer first driving environment information based on a deep learning algorithm using the external image information of the vehicle;
obtain second driving environment information by using the external signal information; and
determine the driving environment information of the vehicle by using both the first driving environment information and the second driving environment information, wherein the driving environment information determination unit is configured to:
when first detailed information of the first driving environment information is different from second detailed information of the second driving environment information, determine the first detailed information or the second detailed information as detailed information of the driving environment information based on the comparison result of a probability value related to the first detailed information and a threshold value corresponding to the probability value, and
wherein the threshold value is set differently depending on a type of corresponding detailed information.

11. The apparatus of claim 10, wherein the type of the detailed information includes at least one of:
weather information of a location at which the vehicle is driving;
type information about the road on which the vehicle is driving;
congestion information about the road on which the vehicle is driving;
visual field brightness information of the vehicle;
information about a sun direction and an altitude; and
legal information of the location at which where the vehicle is driving.

12. The apparatus of claim 11, wherein the determined deep learning model is determined based on a first information set among the type of the detailed information, and
wherein the determined deep learning parameter set is determined based on a second information set including the first information set among the type of the detailed information.

13. The apparatus of claim 12, wherein the first information set includes the type information about the road on which the vehicle is driving.

14. A computer-readable recording medium storing a program for performing the deep learning algorithm configuring method for the autonomous driving in claim 1.
